(19) United States
(12) Patent Application Publication
(10) Pub. No.: US 2013/0278929 A1
(43) Pub. Date: Oct. 24, 2013

(54) RAMAN SPECTROSCOPY

(71) Applicants: Alexandre M. Bratkovski, Mountain View, CA (US); R. Stanley Williams, Portola Valley, CA (US); Zhiyong Li, Foster City, CA (US)

(72) Inventors: Alexandre M. Bratkovski, Mountain View, CA (US); R. Stanley Williams, Portola Valley, CA (US); Zhiyong Li, Foster City, CA (US)

(21) Appl. No.: 13/451,290

(22) Filed: Apr. 19, 2012

(51) Int. Cl. G01J 3/44

(52) U.S. Cl. 356/301

(57) ABSTRACT

Apparatus, methods, and hollow metal waveguides to perform surface-enhanced Raman spectroscopy are disclosed. An example apparatus includes a hollow metal waveguide to direct Raman photons from an intermediate location within a volume of the hollow metal waveguide toward a distal end of the hollow metal waveguide, and a mirror to direct incident light from a light source to the intermediate location within the volume of the hollow metal waveguide and to direct at least some of the Raman photons toward the distal end.

### BACKGROUND

Raman spectroscopy is a spectroscopic technique used in condensed matter physics and chemistry to study vibrational, rotational, and other low-frequency modes of a molecular system.

### BRIEF DESCRIPTION OF THE DRAWINGS

FIG. 1 is a side view of an example surface-enhanced Raman spectroscopy analyzer including light reflected off of a mirror to a sample constructed in accordance with the teachings of this disclosure.

FIG. 2 is a side view of the example surface-enhanced Raman spectroscopy analyzer of FIG. 1 including Raman photons directed toward a spectrometer at a distal end of the analyzer.

FIG. 3 illustrates another example surface-enhanced Raman spectroscopy analyzer.

FIG. 4 is a plan view of another example surface-enhanced Raman spectroscopy analyzer.

FIG. 5 is a flowchart representative of an example method to perform surface-enhanced Raman spectroscopy.

FIG. 6 is a flowchart representative of another example method to perform surface-enhanced Raman spectroscopy.

FIG. 7 illustrates an example apparatus constructed in accordance with the teachings of this disclosure.

FIG. 8 illustrates an example horn-shaped hollow metal waveguide constructed in accordance with the teachings of this disclosure.

FIG. 9 illustrates another example surface-enhanced Raman spectroscopy analyzer.

### DETAILED DESCRIPTION

Example apparatus, methods, and hollow metal waveguides are disclosed herein. Example apparatus, methods, and hollow metal waveguides disclosed herein may be used to perform surface-enhanced Raman spectroscopy.

Briefly, Raman spectroscopy refers to determining properties of a material by observing Raman photons generated as a result of applying a known wavelength of incident light to a material sample. Surface-enhanced Raman spectroscopy (also referred to as surface-enhanced Raman scattering spectroscopy, SERS) refers to Raman spectroscopy where the number of Raman photons generated by the material sample is enhanced by applying the material sample to a metal surface (e.g., silver, gold, or copper). SERS is often used to study monolayers of materials adsorbed on metals. However, typical optical systems for performing Raman spectroscopy include an optical microscope that focuses light from a source onto an analyte, and the Raman spectrum emitted from the analyte is gathered through the same optical system. Collecting an emission spectrum in this manner is inefficient and these optical systems are often bulky.

Known SERS analyzers apply incident light to a material sample and then collect the scattered Raman photons from the material sample. However, these known SERS analyzers collect a lower percentage of the scattered Raman photons. As a result, processing of the collected Raman photons is less efficient and more prone to mischaracterization due to the low signal-to-noise ratio of the collected Raman photons. This loss of efficiency can be substantial, especially when multiple samples are to be analyzed in succession and the analyzer must perform extensive processing for each of the samples.

In contrast to known SERS analyzers, example apparatus, methods, and hollow metal waveguides described herein are capable of performing more rapid SERS analysis on one or more material samples than previous SERS analyzers. Some example apparatus, methods, and hollow metal waveguides disclosed herein use horn-shaped hollow metal waveguides to direct Raman photons scattering from a material sample toward a spectrometer located at a distal end of the horn-shaped hollow metal waveguide. Some such example apparatus, methods, and hollow metal waveguides include a mirror at a proximal end of the horn-shaped hollow metal waveguide (e.g., opposite the distal end). The mirror directs incident light (e.g., from a light source external to the horn-shaped hollow metal waveguide) to an intermediate location within the horn-shaped hollow metal waveguide (e.g., to a location of the material sample within the horn-shaped hollow metal waveguide, a focal point of the horn-shaped hollow metal waveguide to promote collimation of the Raman photons, etc.).

Some example apparatus, methods, and hollow metal waveguides disclosed herein have compact physical dimensions. For example, some apparatus, methods, and hollow metal waveguides disclosed herein have hollow metal waveguide dimensions less than 5 millimeters (mm)×3 mm×1 mm.

Example horn-shaped hollow metal waveguides disclosed herein include a first opening at a proximal end to receive incident light and a second opening at a distal end to provide Raman photons to a spectrometer. In some such examples, the hollow metal waveguide is shaped to direct the light toward an intermediate location in the hollow metal waveguide and to direct the Raman photons from the intermediate location to the distal end.

Disclosed example apparatus include a light source to generate incident light at a first frequency, a hollow metal waveguide to direct Raman photons from an intermediate location within a volume of the hollow metal waveguide toward a distal end of the hollow metal waveguide, and a mirror to direct the incident light from the light source to the intermediate location within the volume of the hollow metal waveguide and to direct at least some of the Raman photons toward the distal end.

Example methods disclosed herein include applying incident light at a first frequency to an intermediate location within the volume of a hollow metal waveguide via a mirror disposed in the hollow metal waveguide, the hollow metal waveguide to direct Raman photons from the intermediate location toward a distal end of the hollow metal waveguide and to reflect Raman photons toward the distal end, and collecting the Raman photons at the distal end of the hollow metal waveguide.

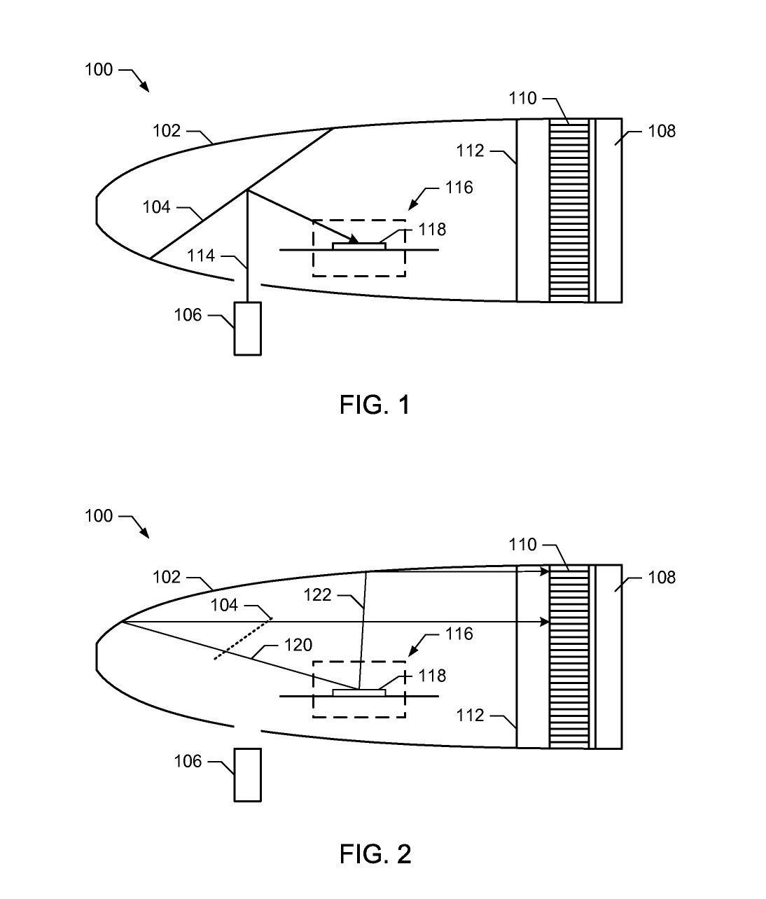

FIG. 1 is a side view of an example surface-enhanced Raman spectroscopy (SERS) analyzer 100 constructed in accordance with the teachings of this disclosure. The example SERS analyzer 100 of FIG. 1 may be used to perform SERS on a material sample and/or on multiple material samples in succession. The SERS analyzer 100 of FIG. 1 includes a hollow metal waveguide 102, a mirror 104, light source(s) 106, a spectrometer 108, a grating 110, and a filter 112.

The example hollow metal waveguide 102 of FIG. 1 is horn-shaped. In some examples, a horn shape is a shape having a smaller cross-section at a proximal end and a larger cross-section at a distal end, where the cross-sections are taken parallel to the proximal and distal ends (e.g., perpendicular to a central axis of the waveguide 102). An example of a horn shape that may be used to implement the hollow metal waveguide 102 is a parabolic hollow metal waveguide. The cross-section of the example waveguide is not necessarily symmetrical and may have a generally elongated (e.g., elliptical, rectangular, etc.) cross-section to reduce a time to collect Raman photons. In some examples, a distance between the distal and proximal ends of the hollow metal waveguide 102 is greater than any dimension of a cross-section of the hollow metal waveguide 102, where the cross-section is taken parallel to the distal and proximal ends (e.g., perpendicular to a central axis of the waveguide 102).

The example mirror 104 is positioned within the hollow metal waveguide 102 on a proximal end of the hollow metal waveguide 102. The mirror 104 is angled such that incident light 114 (e.g., electromagnetic frequency waves from the light source(s) 106) strikes the mirror 104 and is directed by the mirror 104 to an intermediate location 116 within the hollow metal waveguide 102. Prior to the incident light 114 striking the mirror 104, a material sample 118 (e.g., a material to be sampled placed on a metal surface) is placed at the intermediate location 116. When the incident light 114 strikes the mirror 104, the mirror 104 directs the incident light 114 to the intermediate location 116, where the incident light 114 strikes the material sample 118.

The example mirror 104 of FIG. 1 also reflects Raman photons toward the spectrometer 108. In some examples, the position of the mirror 104 causes Raman photons striking the mirror 104 to reach the spectrometer 108 more quickly than those photons would reach the spectrometer 108 if the mirror 104 was not provided. While the mirror 104 is referred to herein as singular, there may be multiple mirrors. Additionally or alternatively, the mirror(s) 104 may be flat, convex, concave, and/or any other shape(s) to direct incident light to the intermediate location and/or direct Raman photons toward the distal end of the hollow metal waveguide 108.

The example light source(s) 106 of FIG. 1 are vertical-cavity surface emitting lasers (VCSELs). Other types of light source(s), such as edge-emitting lasers and/or other types of solid state lasers, may additionally or alternatively be used. The light source(s) 106 may be implemented using any other past, present, and/or future types of lasers and/or light source(s) useful for performing SERS analysis. The example light source(s) 106 produce one or more distinct wavelengths and/or beams of incident light 114. The mirror 104 may direct the multiple wavelengths and/or beams at the same material sample at approximately a same time (e.g., simultaneously). In some other examples, the light source(s) 106 provide the different wavelengths of incident light 114 sequentially. The example light source(s) 106 are positioned outside of the hollow metal waveguide 102 and generate the incident light toward the mirror 104.

In some examples, the mirror 104 directs respective ones of the multiple wavelengths and/or beams at different samples at approximately a same time (e.g., simultaneously). Applying incident light to different samples simultaneously may be used to increase a number of Raman photons that are generated if, for example, the multiple samples include the same substance.

The example spectrometer 108 (or spectroscope/spectrograph) of FIG. 1 may be any type of spectrometer capable of collecting Raman photons. The example grating 110 of FIG. 1 is constructed to pass sufficient ranges of light wavelengths so as to permit the Raman photons to traverse the grating 110 to the spectrometer 108.

The example filter(s) 112 of FIG. 1 are notch filters that substantially attenuate (e.g., eliminate) a small (e.g., notch) range of wavelengths centered on the wavelengths of the incident light 114. The incident light 114 has a significantly higher energy than the Raman photons. As a result, permitting the incident light 114 to reach the spectrometer 108 would reduce the sensitivity of the spectrometer 108 and make it more difficult for the spectrometer 108 to identify the Raman photons. By providing the filter(s) 112, interference at the spectrometer 108 is reduced and the sensitivity of the spectrometer 108 is increased.

FIG. 2 is a side view of the example surface-enhanced Raman spectroscopy analyzer 100 of FIG. 1 illustrating Raman photons 120, 122 directed toward the spectrometer 108 at a distal end of the analyzer 100. When the incident light 114 of FIG. 1 strikes the material sample 118, the material sample 118 releases the Raman photons 120, 122. The Raman photons may be scattered in multiple direction(s) from the material sample 118, including toward or away from the spectrometer 108.

The Raman photons 120, 122 reflect off of the hollow metal waveguide 102. Thus, the shape of the example hollow metal waveguide 102 of FIGS. 1 and 2 directs the Raman photons 120, 122 toward the distal end (e.g., toward the spectrometer 108). In some examples, the shape of the hollow metal waveguide 102 (e.g., a horn shape) causes the hollow metal waveguide 102 to direct the Raman photons 120, 122 toward the distal end (e.g., toward the spectrometer 108) by reflecting towards the distal end and/or collimating any Raman photons traveling in the direction of the proximal end. For example, a hollow metal waveguide 102 having a parabolic shape has a focal point (e.g., approximately the intermediate location, where the material sample is located), to which light traveling perpendicular to the central axis between the proximal and distal ends would be directed upon reflection off of the parabolic hollow metal waveguide. The example intermediate location 116 of FIG. 1 may be selected to promote collimation of Raman photons reflecting off of the waveguide 102. Conversely, light (e.g., Raman photons) traveling from the focal point (e.g., the intermediate location 116 of FIG. 1) is directed toward the distal end upon reflection off of the hollow metal waveguide.

Because the Raman photons 120, 122 are directed toward the spectrometer 108, the spectrometer 108 collects a higher percentage of the Raman photons scattered from the material sample 118 in a given period of time than known analyzers would collect in the same period of time. Accordingly, the example SERS analyzer 100 of FIGS. 1 and 2 collect an adequate amount of the Raman photons (e.g., to make an accurate identification of the material sample 118) more rapidly than known analyzers and/or collect Raman photons from multiple samples simultaneously.

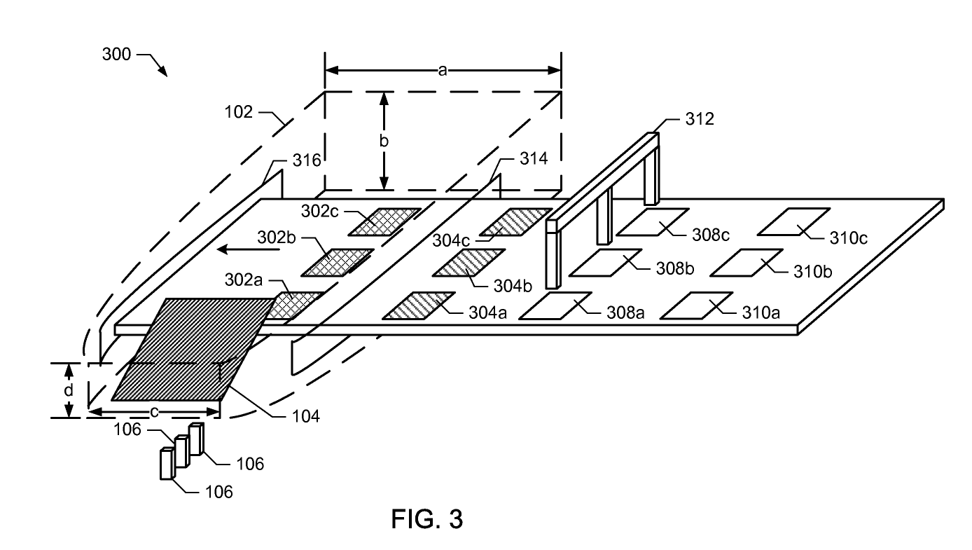

FIG. 3 illustrates another example surface-enhanced Raman spectroscopy analyzer 300. As illustrated in FIG. 3, the example SERS analyzer 100 includes the hollow metal waveguide 102, the mirror 104, and multiple ones of the light sources 106 of FIG. 1. For clarity of illustration, the example spectrometer 108, the example grating 110, and the example filter(s) 112 are not shown in FIG. 3. The example hollow metal waveguide 102 is illustrated in FIG. 3 in a perspective view to demonstrate an example horn-shape that may be used for the hollow metal waveguide 102.

The horn-shape of the example hollow metal waveguide 102 has a larger cross section at the distal end and a smaller cross-section at the proximal end (e.g., a>c and b>d in FIG. 3). Furthermore, the example cross-sections are not necessarily completely symmetrical (e.g., cross sections may be rectangular, elliptical, triangular, etc., or a>b and c>d in FIG. 3). However, in some other examples, some or all cross-sections of the hollow metal waveguide are partially or completely symmetrical.

The example SERS analyzer 300 is shown in FIG. 3 configured to perform SERS analysis on multiple material samples 302a-302c, 304a-304c. The material samples 302a-302c, 304a-304c are arranged on a substrate 306. The example sample zones include material samples 302a-302c, 304a-304c. Each of the material samples comprises a material to be characterized or analyzed deposited on metal surfaces 308a, 308b, 308c, 310a, 310b, 310c (e.g., copper, gold, silver). The metal surfaces 308a-310c may be affixed or attached to the substrate 306 and/or may be a part of (e.g., integral to) the substrate 306. In the example of FIG. 3, the SERS analyzer 100 includes a dispenser 312 to deposit a material to be characterized or analyzed onto the metal surfaces 308a-310c.

The example hollow metal waveguide 102 includes multiple slots 314, 316 to receive the substrate 306. During operation, the example substrate 306 is inserted into the example hollow metal waveguide 102 (e.g., via the first slot 314 in the hollow metal waveguide 102) to position one or more of the material samples 302a-304c at respective intermediate locations within the hollow metal waveguide 102. In the example of FIG. 3, the material samples 302a-302c are positioned at 3 different intermediate locations within the hollow metal waveguide 102.

When the material sample(s) 302a-302c are in position, the example SERS analyzer 100 performs SERS analysis (e.g., via the hollow metal waveguide 102, the mirror 104, the light sources 106, and the spectrometer 108) on one of the material samples 302a-302c at a time. To analyze the samples one at a time, the light sources 106 reflect incident light off of the mirror 104 to one of the material samples (e.g., the material sample 302b) and collects the resulting Raman photons. After analyzing the material samples 302a-302c, the example substrate 306 is advanced (e.g., through a second slot 316 in the hollow metal waveguide 102 opposite the first slot 314) such that the material samples 302a-302c are removed from the hollow metal waveguide 102. One or more subsequent material samples 304a-304c are positioned in the respective intermediate location(s) for analysis. The material samples 302a-302c need not be immediately removed from the hollow metal waveguide 102 after analysis, because the incident light from the light sources 106 may be focused on the locations where the subsequent material samples 304a-304c are positioned.

The example light sources 106 may apply (e.g., via the mirror 104) different wavelengths of incident light to the same location(s) on the material sample(s) 302a-304c. In the example of FIG. 3, the mirror 104 extends across the hollow metal waveguide 102 (e.g., to the sides of the hollow metal waveguide 102 in the directions a/c and/or b/d). In some examples, the light sources 106 apply (e.g., via the mirror 104) the different wavelengths of incident light to different locations of the same sample (e.g., the sample 302a). In some other examples, the light sources apply (e.g., via the mirror 104) the different wavelengths of incident light to different samples (e.g., first incident light to the first sample 302a and second incident light to the second sample 302b).

In the example of FIG. 3, the substrate 306 is conveyed through the slots 314, 316 to rapidly analyze sequential samples deposited on the same substrate 306. In some other examples, a first substrate 306 containing first material samples (e.g., the material samples 302a-302c) is removed from the hollow metal waveguide 102 via the first slot 314 and a second substrate 306 containing second material samples (e.g., the material samples 304a-304c) is inserted into the first slot 314. In such examples, the second slot 316 may be omitted to reduce escape of Raman photons and, thus, improve the captured percentage of Raman photons by the spectrometer.

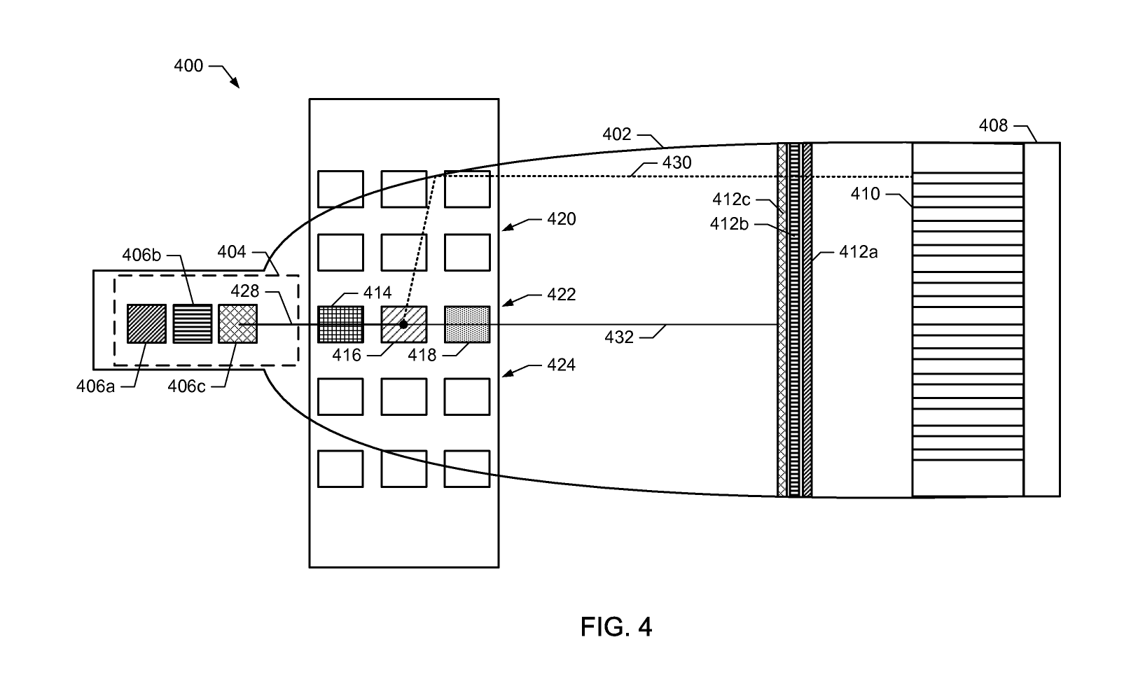

FIG. 4 illustrates a plan view of another example SERS analyzer 400. The example SERS analyzer 400 of FIG. 4 includes a hollow metal waveguide 402, a mirror 404, multiple light sources 406a, 406b, 406c, a spectrometer 408, a diffraction grating 410, and multiple notch filters 412a, 412b, 412c. The example SERS analyzer 400 of FIG. 4 may be used to perform SERS analysis on one or more material samples 414, 416, 418 and/or multiple sets of material samples 420, 422, 424 in sequence. The material samples 414-418 and sets of material samples 420-424 illustrated in FIG. 4 are deposited on a same substrate 426 that may be conveyed through the hollow metal waveguide 402.

The example hollow metal waveguide 402 of FIG. 4 has a horn shape (e.g., a parabolic shape). The light sources 406a-406c are positioned toward a proximal end of the hollow metal waveguide 402 and the spectrometer 408 is positioned at a distal end of the hollow metal waveguide 402. The light sources 406a-406c generate incident light 428 that is directed (e.g., by the mirror 404) to the respective location of the material sample under test (e.g., the material sample 416 as illustrated in FIG. 4). The example light sources 406a-406c generate incident light 428 having different wavelengths. Some example wavelengths that may be generated by the light sources 406a-406c include 550 nanometers (nm), 650 nm, 730 nm, 1100 nm, and 1300 nm.

When struck by the incident light 428, the example material sample 416 releases (e.g., scatters) Raman photons 430. The shape of the hollow metal waveguide 402 causes the Raman photons 430 to be directed toward the distal end (e.g., toward the spectrometer 408). For example, the hollow metal waveguide directs the Raman photons 430 toward the distal end (e.g., toward the spectrometer 408) by reflecting towards the distal end and/or collimating any of the Raman photons 430 that are traveling in the direction of the proximal end. After a number of reflections off of the hollow metal waveguide 402, any Raman photons 430 that were initially scattered toward the proximal end are directed toward the distal end to be collected by the spectrometer 408. Thus, the example SERS analyzer 400 collects a higher percentage of the scattered Raman photons 430 in a given period of time than prior art analyzers.

On striking the material sample 416, a portion of the incident light 428 is reflected (e.g., reflected incident light 432) and travels toward the distal end. The notch filter 412c filters out (e.g., absorbs or reflects) light wavelengths in a narrow bandwidth around the wavelength of the light source 412c (e.g., including the wavelength of the incident light 428 and the reflected incident light 432). As a result, the reflected incident light 432 does not traverse the filter 412c. Conversely, the example Raman photons 430 have one or more wavelengths that do not fall within the filtered bandwidth(s) of the notch filters 412a-412c. Therefore, the example Raman photons 430 traverse the filters 412a-412c and are diffracted by the diffraction grating 410 and detected by the spectrometer 408.

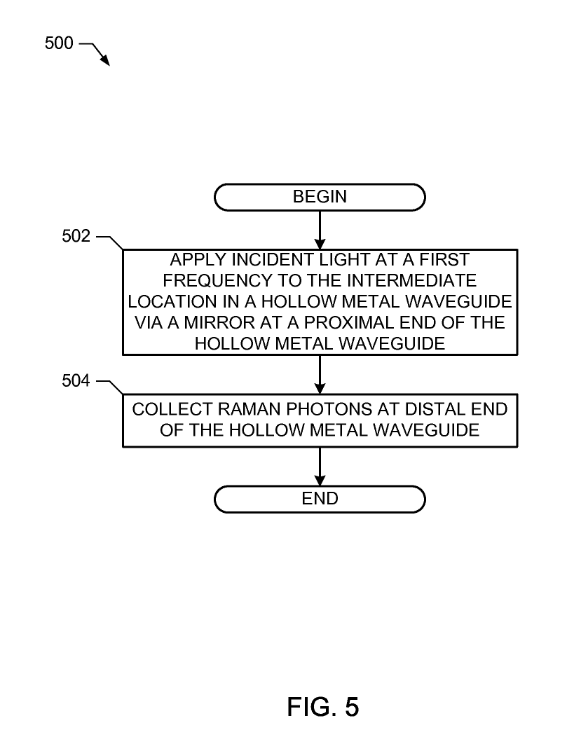

FIG. 5 is a flowchart representative of an example method 500 to perform surface-enhanced Raman spectroscopy (e.g., SERS analysis). The example method 500 may be performed using any of the example SERS analyzers 100, 300, 400 of FIGS. 1-4.

The example method 500 begins with a light source (e.g., one or more of the light source(s) 106, 406a-406c of FIGS. 1-4) applying incident light at a first frequency to an intermediate location in a hollow metal waveguide (e.g., the hollow metal waveguides 102, 402 of FIGS. 1-4) via a mirror (e.g., any of the mirrors 104, 404 of FIGS. 1-4) (block 502). In the example method 500 of FIG. 5, the mirror 104, 404 is located at a proximal end of the hollow metal waveguide 102, 402. The intermediate location is within the hollow metal waveguide 102, 402 (e.g., between a proximal end and a distal end). In some examples, the intermediate location is predetermined.

A spectrometer (e.g., any of the spectrometers 108, 408 of FIGS. 1-4) collect Raman photons at a distal end of the hollow metal waveguide 102, 402 (e.g., opposite the proximal end) (block 504). In some examples, collecting the Raman photons includes waiting a period of time to collect the Raman photons while the hollow metal waveguide 102, 402 directs the photons toward the spectrometer 108, 408. After collecting the Raman photons, the example method 500 may end or, instead, may return to block 502 (e.g., to analyze another material sample).

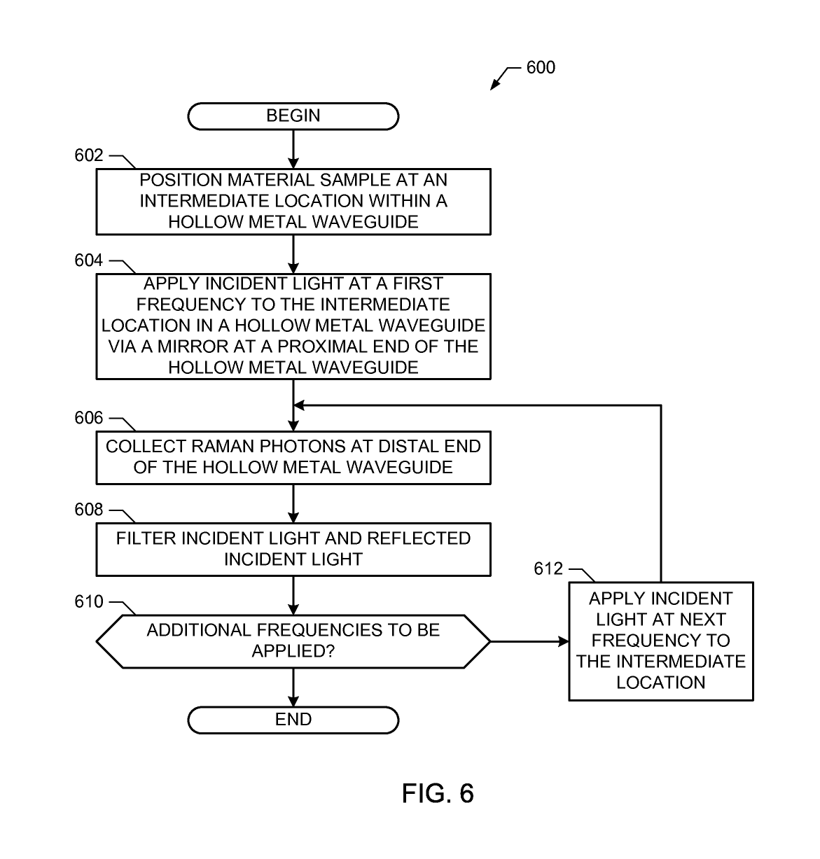

FIG. 6 is a flowchart representative of another example method 600 to perform surface-enhanced Raman spectroscopy (e.g., SERS analysis). The example method 600 may be performed using any of the example SERS analyzers 100, 300, 400 of FIGS. 1-4.

The example method 600 begins by positioning a material sample at an intermediate location within a hollow metal waveguide (e.g., any of the hollow metal waveguides 102, 402 of FIGS. 1-4) (block 602). The intermediate location is within the hollow metal waveguide (e.g., between a proximal end and a distal end). In some examples, the material sample is inserted into the hollow metal waveguide via a slot in the hollow metal waveguide.

A light source (e.g., via any of the light source(s) 106, 406a-406c of FIGS. 1-4) applies incident light at a first frequency to the intermediate location in a hollow metal waveguide 102, 402 via a mirror (e.g., any of the mirrors 104, 404 of FIGS. 1-4) (block 604). In the example method 500 of FIG. 5, the mirror 104, 404 is located at a proximal end of the hollow metal waveguide 102, 402.

A spectrometer (e.g., any of the spectrometers 108, 408 of FIGS. 1-4) collect Raman photons at a distal end of the hollow metal waveguide 102, 402 (e.g., opposite the proximal end) (block 606). In some examples, collecting the Raman photons includes waiting a period of time to collect the Raman photons while the hollow metal waveguide 102, 402 directs the photons toward the spectrometer 108, 408.

In some cases, incident light having different frequencies is to be applied to the same sample. If additional frequencies are to be applied (block 608), a second (or subsequent) light source applies incident light at a next frequency to the intermediate location (e.g., to the material sample) (block 610). The method then returns to block 606 to collect the Raman photons.

On the other hand, if no more frequencies are to be applied to the material sample (block 608), the example method 600 may end or iterate to analyze another material sample.

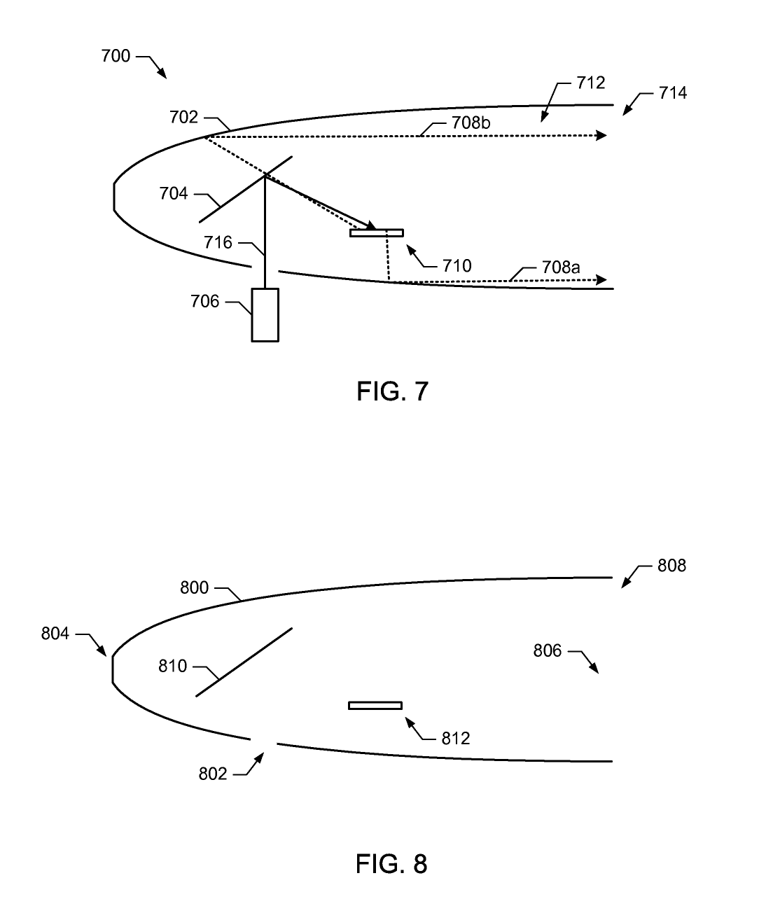

FIG. 7 illustrates an example apparatus 700 constructed in accordance with the teachings of this disclosure. The example apparatus 700 of FIG. 7 includes a hollow metal waveguide 702 and a mirror 706. The example hollow metal waveguide 702 directs Raman photons 708a, 708b from an intermediate location 710 within a volume 712 of the hollow metal waveguide 702 toward a distal end 714 of the hollow metal waveguide 702. The example mirror 706 directs incident light 716 at a first frequency to the intermediate location 710 within the volume 712 of the hollow metal waveguide 702. The example mirror 706 also directs at least some of the Raman photons (e.g., the Raman photon 708b) toward the distal end 714 of the hollow metal waveguide 702.

FIG. 8 illustrates an example horn-shaped hollow metal waveguide 800 constructed in accordance with the teachings of this disclosure. The example horn-shaped hollow metal waveguide 800 includes a first opening 802 at a proximal end 804 to receive incident light and a second opening 806 at a distal end 808 to provide Raman photons to a spectrometer. The hollow metal waveguide 800 includes a mirror 810 and is shaped to direct the incident light toward an intermediate location 812 in the hollow metal waveguide 800 and to direct the Raman photons from the intermediate location 812 to the distal end 808.

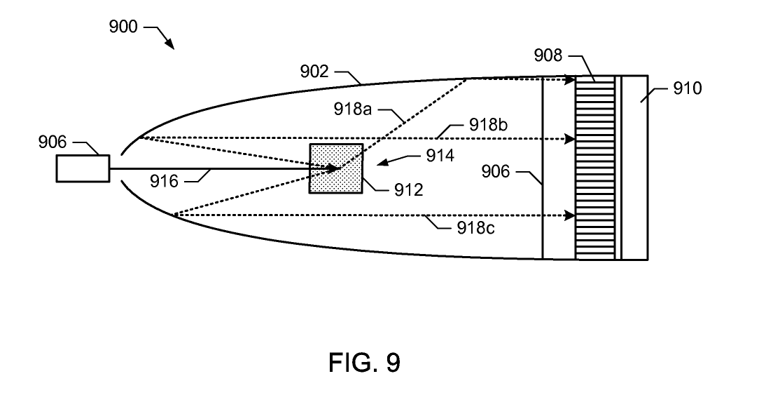

FIG. 9 illustrates another example surface-enhanced Raman spectroscopy analyzer 900. The example of FIG. 9 includes a horn-shaped hollow-metal waveguide 902, a light source 904, one or more filters 906, a grating 908, and a spectrometer 910. A material sample 912 (e.g., an analyte) is placed at an intermediate location 914 (e.g., a focal point of the waveguide 902).

In contrast with the example of FIGS. 1 and 2, the example analyzer 900 of FIG. 9 does not include a mirror. Instead, the example light source 904 directs incident light 916 directly at the material sample 912 (e.g., via a gap in the waveguide 902. The example material sample 912 scatters Raman photons 918a, 918b, 918c. Because the material sample 912 (e.g., the source of the scattered Raman photons 918a-918c) is located at the focal point of the waveguide 902, the example waveguide 902 increases collimation at the grating 908 of any of the Raman photons 918a-918c reflecting off of the waveguide 902.

Example apparatus, methods, and hollow metal waveguides have been disclosed herein to perform SERS analysis. Example apparatus, methods, and hollow metal waveguides disclosed herein provide more rapid SERS analysis than known analyzers. Additionally, example apparatus, methods, and hollow metal waveguides disclosed herein may be more physically compact than known analyzers.

Although certain methods, apparatus, and articles of manufacture have been described herein, the scope of coverage of this patent is not limited thereto. To the contrary, this patent covers all methods, apparatus, and articles of manufacture falling within the scope of the claims.

What is claimed is:

1. An apparatus, comprising:
a hollow metal waveguide to direct Raman photons from an intermediate location within a volume of the hollow metal waveguide toward a distal end of the hollow metal waveguide; and
a mirror to direct incident light from a light source to the intermediate location within the volume of the hollow metal waveguide and to direct at least some of the Raman photons toward the distal end.

2. An apparatus as defined in claim 1, further comprising a spectrometer positioned at the distal end to collect at least some of the Raman photons.

3. An apparatus as defined in claim 1, further comprising a filter to permit the Raman photons to travel to the distal end and to at least partially block the incident light.

4. An apparatus as defined in claim 1, further comprising a light source, wherein the light source is a vertical cavity surface emitting laser.

5. An apparatus as defined in claim 1, wherein at least one cross-section of the hollow metal waveguide has a generally parabolic shape.

6. An apparatus as defined in claim 5, wherein a cross-section of the hollow metal waveguide parallel to the distal end has a first dimension that is different than a second dimension of the cross-section.

7. An apparatus as defined in claim 1, further comprising a first light source and a second light source to generate second incident light at a second frequency, wherein the mirror is to direct the second incident light approximately to the intermediate location or to a second intermediate location within the volume of the hollow metal waveguide.

8. An apparatus as defined in claim 1, wherein a material sample is to be placed at the intermediate location, the sample to scatter the Raman photons in response to the mirror directing the incident light at the intermediate location.

9. An apparatus as defined in claim 8, wherein the intermediate location comprises a volume within the hollow metal waveguide, the material sample to be placed within the volume.

10. An apparatus as defined in claim 1, wherein the hollow metal waveguide is to direct the Raman photons toward the distal end by reflecting toward the distal end any ones of the Raman photons traveling in the direction of the proximal end.

11. An apparatus as defined in claim 1, wherein a distance between the distal and proximal ends of the hollow metal waveguide is greater than any dimension of a cross section of the hollow metal waveguide taken parallel to the distal and proximal ends.

12. A method, comprising:
applying incident light at a first frequency to an intermediate location within a hollow metal waveguide via a mirror disposed in the hollow metal waveguide, the hollow metal waveguide to direct Raman photons from the intermediate location toward a distal end of the hollow metal waveguide and to reflect Raman photons toward the distal end; and
collecting the Raman photons at the distal end of the hollow metal waveguide.

13. A method as defined in claim 12, further comprising filtering out the incident light at the first frequency.

14. A method as defined in claim 12, further comprising inserting a material sample into the hollow metal waveguide via a first slot in the hollow metal waveguide.

15. A method as defined in claim 14, further comprising feeding a substrate including the material sample through the first slot and a second slot to position the material sample at the intermediate location.

16. A method as defined in claim 12, further comprising applying second incident light at a second frequency to the mirror, the mirror to direct the second incident light to the intermediate location; and
collecting second Raman photons at the distal end of the hollow metal waveguide.

17. A horn-shaped hollow metal waveguide, comprising a first opening at a proximal end to receive incident light and a second opening at a distal end to provide Raman photons to a spectrometer, and shaped to direct the incident light toward an intermediate location in the hollow metal waveguide and to direct the Raman photons from the intermediate location to the distal end.

18. A horn-shaped hollow metal waveguide as defined in claim 17, wherein a distance between the distal and proximal ends of the hollow metal waveguide is greater than any dimension of a cross section of the hollow metal waveguide taken parallel to the distal and proximal ends.

19. A horn-shaped hollow metal waveguide as defined in claim 17, wherein the hollow metal waveguide is to direct the Raman photons toward the distal end by reflecting toward the distal end any Raman photons traveling in the direction of the proximal end.

20. A horn-shaped hollow metal waveguide as defined in claim 17, further comprising a slot to receive a material sample.
